(19) United States
(12) Patent Application Publication
(10) Pub. No.: US 2017/0193544 A1
(43) Pub. Date: Jul. 6, 2017

(54) MODIFICATION OF CONTENT ACCORDING TO USER ENGAGEMENT

(71) Applicant: eBay Inc., San Jose, CA (US)

(72) Inventors: Dane Glasgow, Los Altos, CA (US); Matthew Bret MacLaurin, Santa Cruz, CA (US); Neville Rhys Newey, Pleasanton, CA (US); Justin Van Winkle, San Jose, CA (US); Christopher Michael Hall, Paris (FR); Trista Mcneill, (US); David Ramadge, San Jose, CA (US)

(21) Appl. No.: 14/984,217

(22) Filed: Dec. 30, 2015

(51) Int. Cl. G06Q 30/02; G06Q 30/06; G06F 3/0481; G06F 1/16; G06F 3/01

(52) U.S. Cl. CPC G06Q 30/0242; G06F 1/163; G06F 3/013; G06F 3/0481; G06Q 30/0643

(57) ABSTRACT

In various example embodiments, a system and method for modification of content according to user engagement are described herein. A user interface that depicts an item page that describes an item available for sale is displayed by the system on a screen of a mobile device. The system receives signals generated by a wearable device worn by a user, and the signals indicate a physical response to the displayed user interface on the screen of the mobile device. The system determines that a level of engagement from the user transgresses a threshold level of engagement, and the determining is based on the received signals. Further, the system modifies the user interface displayed on the screen of the mobile device based on the determining that the level of engagement from the user transgresses the threshold level of engagement.

### TECHNICAL FIELD

Embodiments of the present disclosure relate generally to data processing and, more particularly, but not by way of limitation, to modification of content according to user engagement.

### BACKGROUND

Conventionally, a user viewing a user interface may get bored with content being displayed in the user interface. Accordingly, the user may try to manually navigate through the content in order to skip to other content more interesting to the user.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a block diagram illustrating components of the interface system, according to some example embodiments.

FIGS. 3-5 are flowcharts illustrating operations of the interface system in performing a method of modifying a user interface according to a level of engagement, according to some example embodiments.

FIG. 6 is an example user interface that depicts an item page, according to some example embodiments.

FIG. 7-9 are example user interfaces that depict a modified item page, according to some example embodiments.

FIG. 10 is an example user interface that depicts content of a vehicle, according to some example embodiments.

FIG. 11 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various example embodiments of the subject matter discussed herein. It will be evident, however, to those skilled in the art, that embodiments of the subject matter discussed herein may be practiced without these specific details.

In various example embodiments, a user is viewing a user interface that is displayed on a screen of a mobile device. Further, the user may also be wearing a wearable device while viewing the user interface. The wearable device captures data that indicates a physical response of the user to content being displayed in the user interface. For instance, the physical response of the user includes a facial expression of the user in response to the content displayed in the user interface. As another example, the physical response of the user includes the user's resulting heart rate after viewing the content displayed in the user interface. Other examples include movements of the user after viewing the content displayed in the user interface. In other words, the physical response of the user can be any response that is measured with data captured by the wearable device. Using the captured data, the wearable device generates a signal. Moreover, a system receives the generated signal and determines a level of engagement of the user to the user interface. The level of engagement may range from a high level of engagement to a low level of engagement. The high level of engagement may correspond to a user being very excited whereas a low level of engagement corresponds to a user being bored. Further, the system modifies the user interface based on the determined level of engagement. Modification of the user interface may include making the content more attractive or interesting to the user if a low level of engagement is determined. In further instances, the content may depict an item and modification of the user interface includes enabling purchase of the item depicted in the content if a high level of engagement is determined.

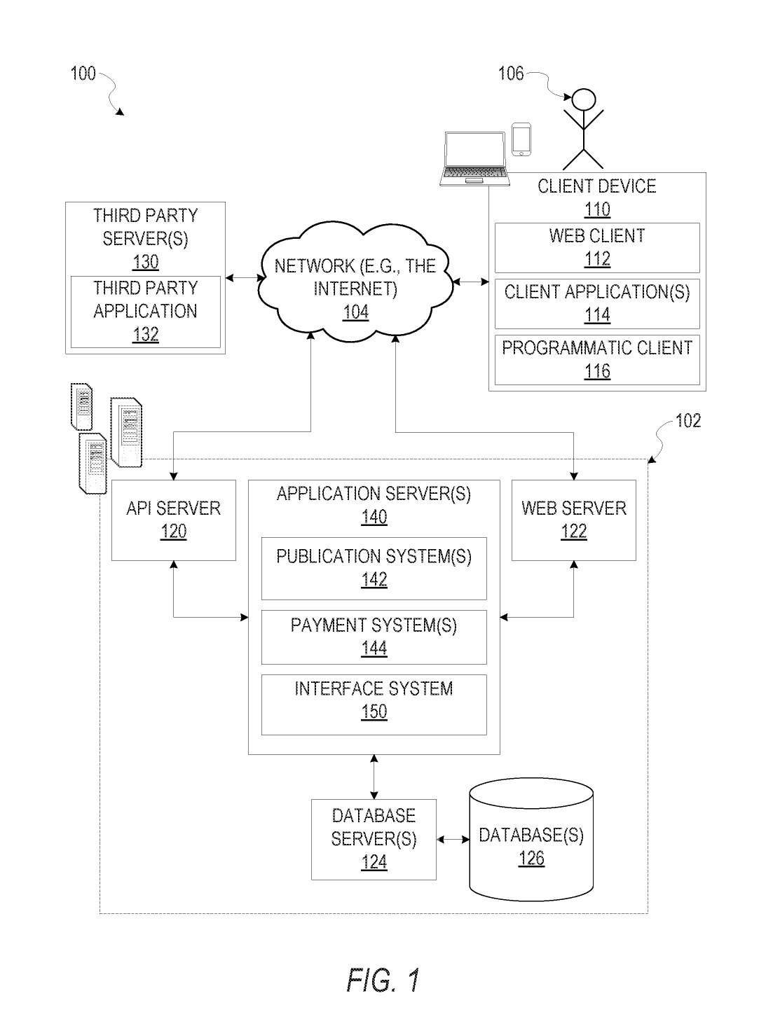

With reference to FIG. 1, an example embodiment of a high-level client-server-based network architecture 100 is shown. A networked system 102, in the example forms of a network-based publication or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Wash. State), a client application 114, and a programmatic client 116 executing on client device 110.

The client device 110 may comprise, but is not limited to, a mobile phone, desktop computer, laptop, portable digital assistants (PDAs), smart phones, tablets, laptops, multi-processor systems, microprocessor-based or programmable consumer electronics, game consoles, set-top boxes, or any other communication device that a user may utilize to access the networked system 102. In some example embodiments, the client device 110 comprises a display module (not shown) to display information (e.g., in the form of user interfaces). In further example embodiments, the client device 110 may comprise one or more of a touch screens, accelerometers, gyroscopes, cameras, microphones, global positioning system (GPS) devices, and so forth. The client device 110 may be a device of a user that is used to perform a transaction involving digital items within the networked system 102. In one embodiment, the networked system 102 is a network-based publication system that responds to requests for product listings, publishes publications comprising item listings of products available on the network-based publication system, and manages payments for these marketplace transactions. For example, one or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client devices 110 include one or more applications (also referred to as “apps”) such as, but not limited to, a web browser, messaging application, electronic mail (email) application, an e-commerce site application (also referred to as a marketplace application), and the like. In some example embodiments, if the e-commerce site application is included in a given one of the client device 110, then this application is configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely if the e-commerce site application is not included in the client device 110, the client device 110 may use its web browser to access the e-commerce site (or a variant thereof) hosted on the networked system 102.

One or more users 106 may be a person, a machine, or other means of interacting with the client device 110. In example embodiments, the user 106 is not part of the network architecture 100, but interacts with the network architecture 100 via the client device 110 or other means. For instance, the user 106 provides input (e.g., touch screen input or alphanumeric input) to the client device 110 and the input is communicated to the networked system 102 via the network 104. In this instance, the networked system 102, in response to receiving the input from the user 106, communicates information to the client device 110 via the network 104 to be presented to the user 106. In this way, the user 106 can interact with the networked system 102 using the client device 110.

An application program interface (API) server 120 and a web server 122 are coupled to, and provide programmatic and web interfaces respectively to, one or more application servers 140. The application servers 140 host one or more publication systems 142 and payment systems 144, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 142. The databases 126 may also store digital item information in accordance with example embodiments.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, publication, or payment functions that are supported by the relevant applications of the networked system 102.

The publication systems 142 provide a number of publication functions and services to users 106 that access the networked system 102. The payment systems 144 likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some example embodiments, the payment systems 144 may form part of the publication system 142.

The interface system 150 provides functionality operable to perform various modifications on a user interface that is displayed to the user on a mobile device. The interface system 150 performs the modifications based on data received from a wearable device that is worn by the user. In some example embodiments, the interface system 150 analyzes signals received from the wearable device to determine an engagement level. In some example embodiments, the interface system 150 communicates with the publication systems 142 (e.g., accessing item listings) and payment system 144. In an alternative embodiment, the interface system 150 may be a part of the publication system 142.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and interface system 150 could also be implemented as standalone software programs, which do not necessarily have networking capabilities.

The web client 112 accesses the various publication and payment systems 142 and 144 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

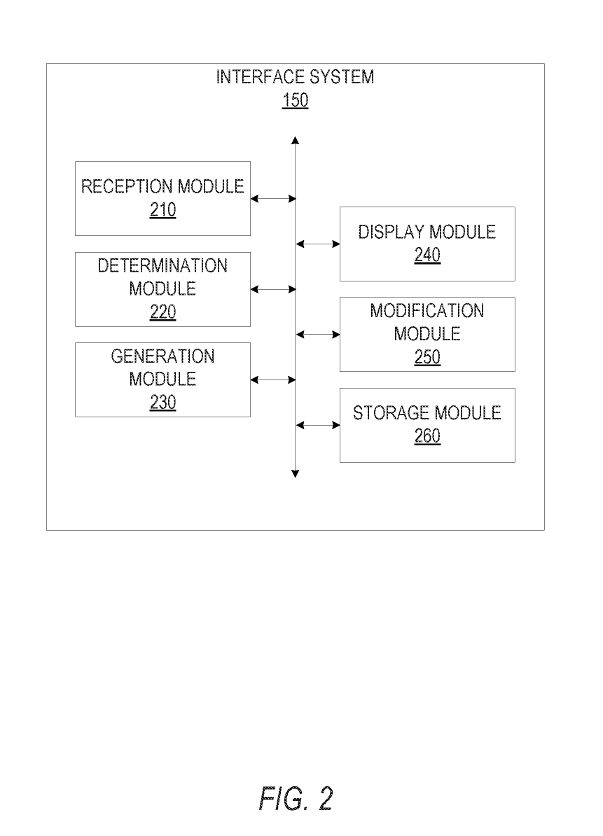

FIG. 2 is a block diagram illustrating components of the interface system 150, according to some example embodiments. The interface system 150 is shown as including a reception module 210, a determination module 220, a generation module 230, a display module 240, a modification module 250, and a storage module 260, all configured to communicate with each other (e.g., via a bus, shared memory, or a switch). Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In various example embodiments, the display module 240 is configured to cause display of a user interface that depicts an item page that describes an item available for sale from a network publication system. The user interface may also depict other content, such as a video clip, a slide show presentation, an electronic book, and the like. For example, a user may be reading an electronic book that is displayed in the user interface. As another example, the user may be viewing a slide show presentation displayed in the user interface. Alternatively, a user may be viewing a movie or video clip that is displayed in the user interface. The display module 240 also causes display of the user interface on a screen of a mobile device. Once displayed, the user interface is also modified by the display module 240. In other words, the display module is further to cause display of modified user interfaces. In additional embodiments, the display module 240 is to cause display of an additional user interface (e.g., additional page) that is generated by the generation module 230, as further explained below.

In various example embodiments, the reception module 210 is configured to receive a signal from a wearable device worn by a user. In further embodiments, the signal is generated by the wearable device worn by the user. The wearable device may be worn by the user and used to gather signals or data regarding the user as the user is viewing the user interface displayed on the screen of the mobile device. For example, the wearable device may include a strap that is used to strap the wearable device on a body part of the user. As another example, the wearable device is held by the user. As another example, the wearable device is included within an article of clothing worn by the user (e.g., placed inside a pocket).

In various example embodiments, the signal indicates a physical response of the user to the displayed user interface on the screen of the mobile device. In further example embodiments, the reception module 210 is to receive information that indicates a result of an eye tracking performed by the wearable device on the user. Moreover, the result of the eye tracking may indicate eye pupil dilation of the user. The result of the eye tracking also indicates an amount of eye movement from the user.

In various example embodiments, the determination module 220 is configured to determine a level of engagement of the user based on the received signal. In other words, the level of engagement corresponds to the physical response of the user as the user is viewing the user interface. More specifically, there is a correlation between the level of engagement and the physical response of the user. For example, the user may be excited when viewing the user interface, and the user will have a physical response that indicates a high level of engagement. Alternatively, the user may get bored when viewing the user interface, and the user will have a physical response that indicates a low level of engagement. In further example embodiments, the determination module 220 determines that the level of engagement of the user transgresses a threshold level of engagement. In some instances, the threshold level of engagement is precomputed and set at a predetermined level of engagement. Alternatively, the threshold level of engagement is dynamic and adjustable. The predetermined level of engagement indicates a criteria that is compared with the determined level of engagement of the user. In other words, the determination module 220 is to determine that the level of engagement is below the threshold level of engagement. Alternatively, the determination module 220 is to determine that the level of engagement is above the threshold level of engagement. In further embodiments, threshold level of engagement is represented by data which is compared with the signal generated by the wearable device.

In further example embodiments, the determination module 220 is configured to determine that a heart rate of the user is above a threshold value. For example, the threshold value indicates a target heart rate (e.g., a number of heart beats per minute). In some instances, the threshold value indicates a change in a measured heart rate. For example, if the user experiences a sudden change in heart rate as a result of being excited, the determination module 220 is able to determine a high level of engagement.

In further example embodiments, the determination module 220 is configured to determine that a facial expression of the user matches a set of predefined criteria. The set of predefined criteria indications an expression, such as a positive facial expression (e.g., an expression of happiness). Since the expression of happiness is considered a high level of engagement, the determination module 220 uses the match with the predefined criteria to determine the high level of engagement from the user. More specifically, the determination module 220 is to determine that the facial expression of the user matches the positive facial expression. From the positive facial expression, the determination module 220 determines that the level of engagement of the user transgresses the threshold level of engagement.

In further example embodiments, the determination module 220 is configured to determine that movement of the user exceeds a threshold amount of movement. For example, the signal from the wearable device may indicate that the user's movement is suddenly accelerated in response to viewing the user interface. Further, the wearable device is worn by the user at a location on the user's body. Moreover, the location on the user's body corresponds to a body part of the user (e.g., arm, head, feet, and the like). Accordingly, the movement of the user corresponds to the movement of the body part of the user. The threshold amount of movement indicates a minimum acceleration rate that the determination module 220 uses to compare with the movement of the user.

In various example embodiments, the modification module 250 is configured to modify the user interface displayed on the screen of the mobile device. More specifically, the modification module 250 modifies content that is depicted in the user interface displayed on the screen of the mobile device. In further example embodiments, the modification of the user interface is performed according to the determined level of engagement of the user. In other words, the modification module 250 is to modify the user interface based on the determining that the level of engagement from the user transgresses the threshold level of engagement. For instance, if the level of engagement of the user is determined to be a high level of engagement, the modification module 250 will modify the user interface to make it easier for the user to purchase the item. Alternatively, if the level of engagement of the user is determined to be a low level of engagement, then the modification module 250 will modify the user interface to make the item more attractive to the user. Accordingly, in further example embodiments, the modification module 250 is to increase a size of a portion of the item page. The portion of the item page may be selectable to initiate a purchase of the item. Alternatively, the portion of the item page may be a description of the item. In further example embodiments, the modification module 250 is to decrease a size of a portion of the item page. For instance, an image of the item may be decreased in size in order to allow for other portions of the item page to be increased, such as the portion of the item page that facilitates purchase of the item.

In the case of the user interface depicting other content, such as a video clip, the modification module 250 is further to increase a size of a portion of the video content. For example, the modification module 250 selects one or more frames from the video content to enlarge. This may include selecting a frame from the video content and enlarging a portion of the selected frame (e.g., increasing the size of a car in the frame that is displayed 3 minutes and 5 seconds into the video clip). In further example embodiments, the modification module 250 is to highlight or indicate a portion of the user interface in order to draw the user's attention. Accordingly, the modification module 250 is further to highlight one or more frames from the video content by marking the one or more frames with additional content, such as a tag or a sticker.

In further example embodiments, the modification module 250 is to change a color of the content. In the case of the item page, the modification module 250 changes a color of the item page to a different color. Moreover, the modification module 250 is to change a color of the user interface displayed on the screen of the mobile device. The color change may be used to attract the attention of the user to displayed user interface, thereby causing a change in the level of engagement of the user.

In further example embodiments, the modification module 250 is to reduce an amount of content displayed in the user interface. The reduction of content may be performed by the modification module 250 in response to a determination by the determination module 220 of a low level of engagement from the user. For example, if the determination module 220 determines a low level of engagement from the user due to the user being bored, the content will be reduced in order to hold the attention of the user. In the case of the user interface depicting other content, such as the video clip, the modification module 250 is further to reduce a number of frames being displayed. For example, the modification module 250 will allow the user to skip to more interesting portions of the video clip. The reduction of content may also be performed by the modification module 250 in response to a determination by the determination module 220 of a high level of engagement from the user. For example, if the determination module 220 determines a high level of engagement due to the fact that the user is interested in an item, content being used to make the item more attractive to the user will also be reduced. In other words, this content may be irrelevant to the user because the user has already expressed a high level of engagement to the content displayed in the user interface. In response, the modification module 250 is to reduce an amount of descriptive information regarding an item from an item page published by the network based publication system. In other words, the modification module 250 is to remove a description of the item available for sale from the item page depicted in the user interface.

In further example embodiments, the modification module 250 is configured to adjust the threshold level of engagement. As stated above, the threshold level of engagement in some example embodiments is dynamic and therefore subject to change or adjustment. For instance, the modification module 250 is configured to increase the threshold level of engagement so that only very high levels of engagement from the user are determined by the determination module 220. Alternatively, the modification module 250 is to decrease the threshold level of engagement so as to only determine very low levels of engagement from the user.

In various example embodiments, the generation module 230 is configured to generate an additional page that includes a field for receiving purchase information from the user. The generation module 230 performs the generation based on the determination that the level of engagement of the user transgresses the threshold level of engagement. In other words, the generation module 230 performs the generation based on the determination that the level of engagement of the user is above the threshold level of engagement (e.g., high level of engagement). More specifically the additional page may be generated based on a determination that the user is attracted to the item or interested in purchasing the item. In further instances, the level of engagement is an engagement score that the determination module 220 uses to compare with a threshold engagement score.

In various example embodiments, the storage module 260 is configured to store in a database an indication of the determined level of engagement of the user (e.g., the determined engagement score). For instance, the storage module stores an indication that the level of engagement of the user is a high level of engagement as the user is viewing content depicted in the user interface. Alternatively, the storage module 260 stores an indication that the level of engagement of the user is low as the user is viewing the user interface. The storage module 260 is further to associate the stored indication of the determined level of engagement of the user with the content displayed in the user interface. Further, the stored indication of the determined level of engagement of the user is later retrieved from the database by the storage module 260, in some example embodiments, for further analysis. For instance, the storage module 260 retrieves the indication in order to performing a ranking of the content. More specifically, content associated with a high level of engagement is ranked higher than content associated with a low level of engagement. The ranking of the content also affects display of the content in the future. For example, content associated with the high level of engagement is shown to users prior to content associated with the low level of engagement.

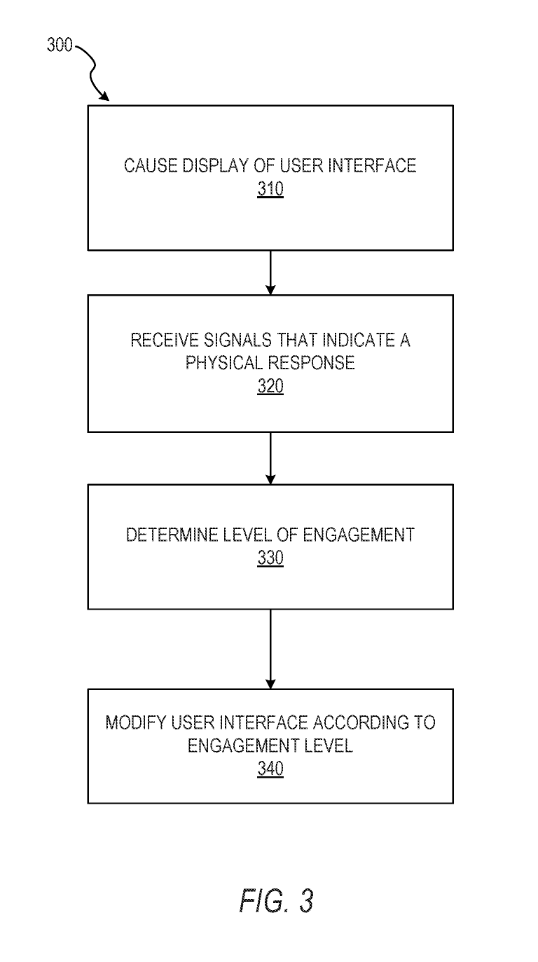

FIG. 3-5 are flowcharts illustrating operations of the interface system 150 in performing a method 300 of modifying a user interface according to a level of engagement, according to some example embodiments. Operations in the method 300 may be performed by the interface system 150, using modules described above with respect to FIG. 2. As shown in FIG. 3, the method 300 includes operations 310, 320, 330, and 340.

At operation 310, the display module 240 causes display of a user interface that depicts an item page that describes an item available for sale from a network publication system. In various example embodiments, the item page includes a description of the item available for sale from the network publication system. Further, the item page includes an image of the item. The display module 240 is further to cause display of the user interface on a screen of a mobile device. Moreover, in some example embodiments, the user interface depicts other content, such as a video clip, a slide show presentation, an electronic book, and the like.

At operation 320, the reception module 210 receives a signal, from a wearable device worn by a user, that indicates a physical response to the displayed user interface. For example, the wearable device may be worn around the user's wrist. The wearable device captures data regarding the user as the user is viewing the screen of the mobile device. For example, the wearable device measures a heart rate of the user, eye pupil dilation of the user, eye movement of the user, movement of the user, facial expressions of the user, and the like. Moreover, the data captured by the wearable device indicate a physical response of the user to the user interface. Also, the wearable device uses the captured data to generate the signal that indicates the physical response of the user to the user interface.

At operation 330, the determination module 220 determines a level of engagement of the user based on the received signal. The level of engagement determines corresponds to the physical response of the user. For example, a high level of engagement corresponds to a physical response that indicates the user is excited with content displayed in the user interface. In further example embodiments, the determination module 220 determines that the level of engagement of the user transgresses a threshold level of engagement. For instance, if the determination module 220 determines that the level of engagement of the user is below the threshold level of engagement, then the determination module 220 further determines a low level of engagement from the user. Alternatively, if the determination module 220 determines that the level of engagement of the user is above the threshold level of engagement, then the determination module 220 further determines a high level of engagement from the user.

In further embodiments, the determination module 220 determines that the signal generated by the wearable device indicates a level of engagement from the user that transgresses the threshold level of engagement. To accomplish this, the determination module 220 is further configured to determine an engagement score based on the signal generated by the wearable device. The engagement score indicates the level of engagement from the user and may have a numerical value. Once the engagement score is determined, the determination module 220 is further configured to compare the engagement score with data that corresponds to the threshold level of engagement. In some instances, the data that corresponds to the threshold level of engagement is a threshold engagement score. As an example, the threshold value indicates an amount of eye pupil dilation of the user. As another example, the threshold value indicates an amount of eye movement from the user.

At operation 340, the modification module 250 modifies the user interface according to the determined level of engagement of the user. For instance, the modification module 250 is to make the contents of the user interface more appealing to a user that is determined to have a low level of engagement. In other words, the modification module 250 is to modify the user interface based on the determining that the level of engagement from the user transgresses the threshold level of engagement.

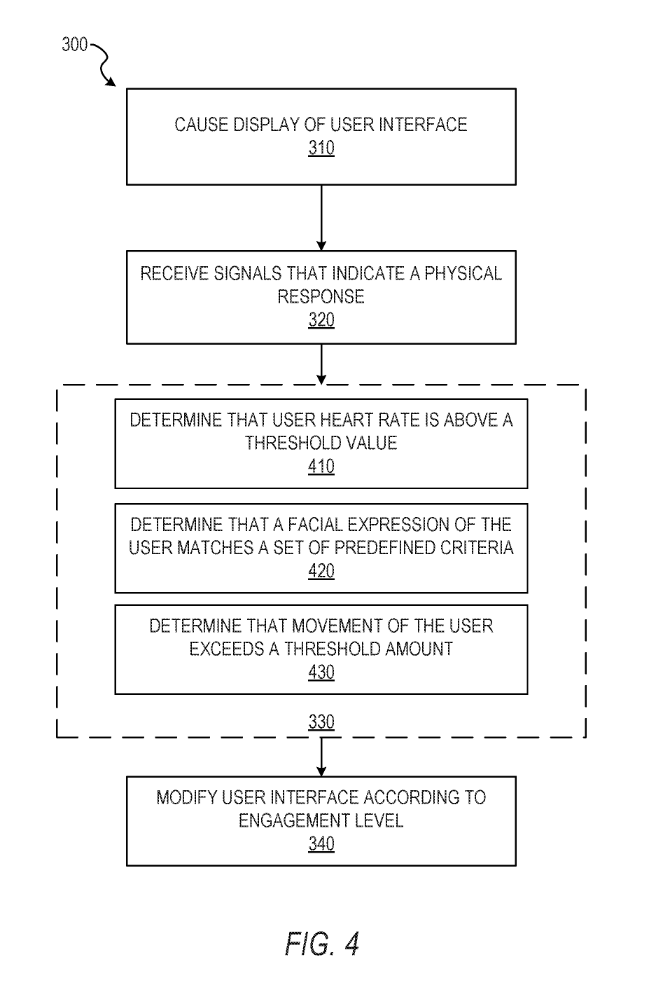

As shown in FIG. 4, the method 300 may include one or more of operations 410, 420, and 430.

At operation 410, the determination module 220 determines that a heart rate of the user is above a threshold value. More specifically, the signal generated by the wearable device indicates the heart rate of the user, which the determination module 220 uses to compare with the threshold value. Further, the threshold value is data that corresponds to or indicates the threshold level of engagement. For instance, the threshold value may be a target heart rate (e.g., number of heart beats per second). In further instances, the threshold value indicates a change in heart rate.

At operation 420, the determination module 220 determines that a facial expression of the user matches a set of predefined criteria. More specifically, the signal generated by the wearable device indicates facial expression of the user, which the determination module 220 uses to compare with the set of predefined criteria. Further, the predefined criteria is data that corresponds to or indicates the threshold level of engagement. The predefined criteria may indicate a positive facial expression. For instance, the predefined criteria may indicate certain facial features (e.g., position of mouth, position of eyebrows, and the like) of the positive facial expression.

At operation 430, the determination module 220 determines that movement of the user exceeds a threshold amount of movement. More specifically, the signal generated by the wearable device indicates the movement of the user, which the determination module 220 uses to compare with the threshold amount of movement. Further, the threshold amount of movement is data that corresponds to or indicates the threshold level of engagement. For example, the threshold amount of movement, in some embodiments, is a threshold speed that is represented as a length per interval of time (e.g., meters per second).

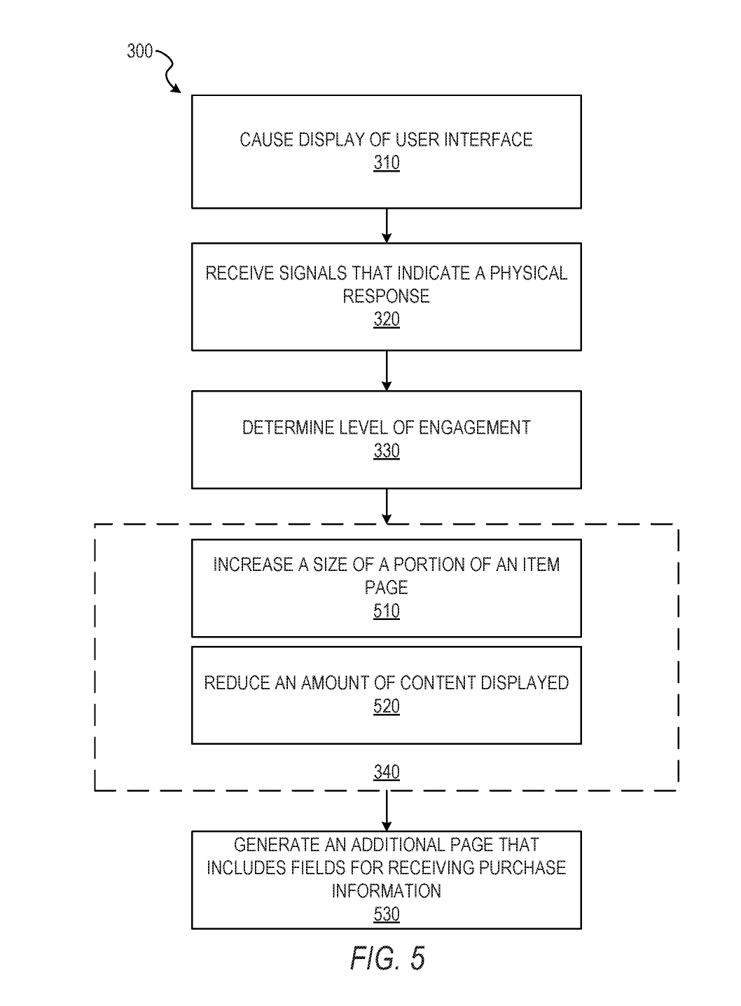

As shown in FIG. 5, the method 300 may include one or more of operations 510, 520, and 530.

At operation 510, the modification module 250 increases a size of a portion of the item page. The portion of the item page may be selectable to initiate a purchase of the item (e.g., a button used to initiate a process for purchase of the item). Alternatively, the portion of the item page may be a description of the item (e.g., the portion of the item page that describes the item available for sale).

At operation 520, the modification module 250 reduces an amount of content displayed in the user interface. For example, if the content being displayed in the user interface is a video clip, the modification module 250 may cause the video to skip from a first section from the video clip to a second section from the video clip, thereby shortening the length of the video clip. Likewise, if the content being displayed is a presentation, the modification module 250 may cause the presentation to skip from a first section to a second section, thereby shortening the length of the presentation. If the content being displayed is an item page, the modification module 250 may remove a description of the item from the page. In other words, the modification module 250 removes or reduces an amount of descriptive information regarding the item from the item page.

At operation 530, the generation module 230 generates an additional page that includes a field for receiving purchase information from the user. The additional page may also include a section for receiving shipment information from the user, such as a shipping address.

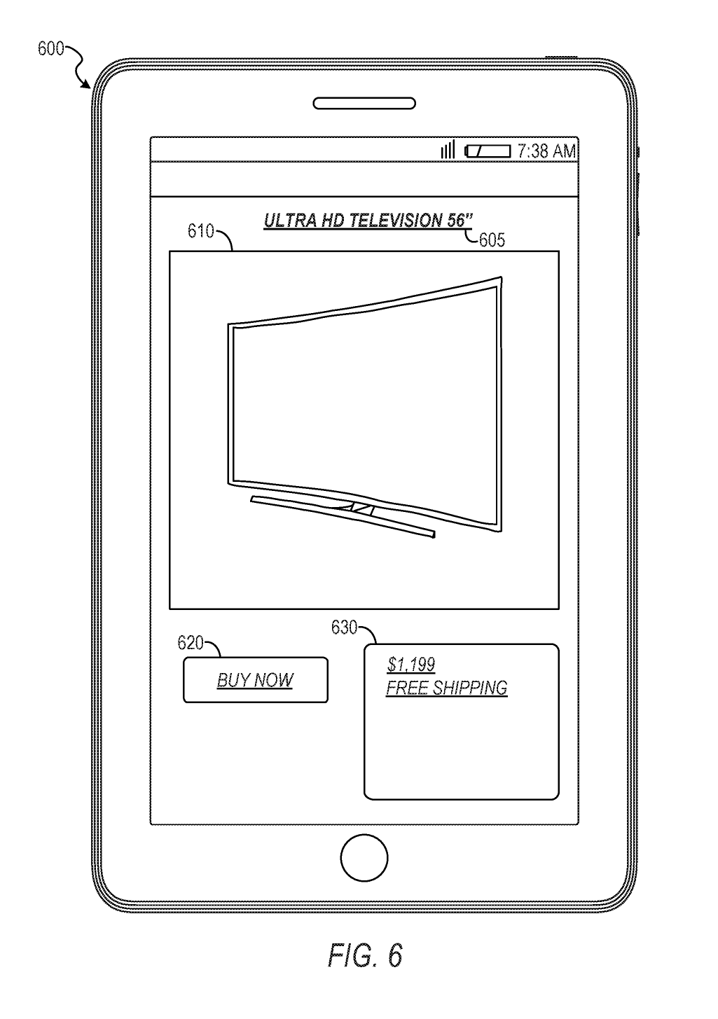

FIG. 6 is an example user interface 600 that depicts an item page, according to some example embodiments. The user interface 600 may be displayed on a screen of a mobile device. As shown in FIG. 6, the user interface 600 includes a title 605, a picture 610 of an item (e.g., television), and a button 620 that is operable to purchase the item. The user interface 600 further includes a 630 description of the item. A user may be viewing the user interface 600 on the mobile device, and a physical response of the user to the item page is measured by a wearable device worn by the user to determine a level of engagement.

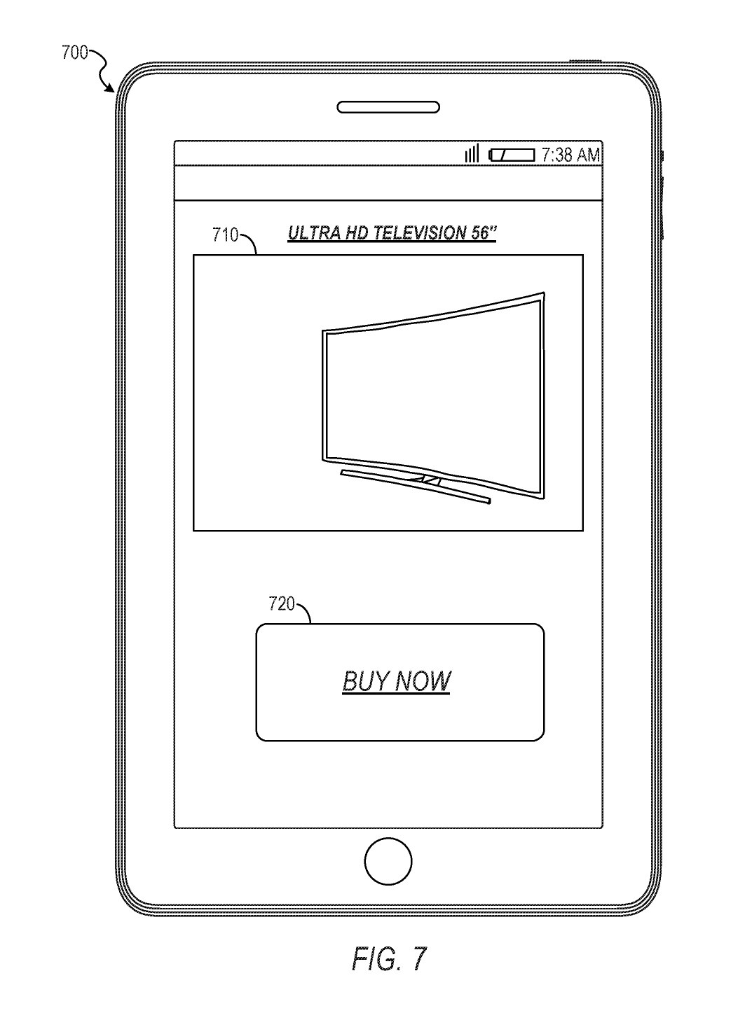

FIG. 7 is an example user interface 700 that depicts a modified item page, according to some example embodiments. The user interface 700 may be displayed on a screen of a mobile device. As shown in FIG. 7, the user interface 700 includes a picture 710 of an item (e.g., television). The user interface 700 also includes a button 720 that is operable to initiate a purchase of the item. Further, the modified item page may be displayed as a result of a high level of engagement to the user interface 600 of FIG. 6.

For example, the button 720 of FIG. 7 corresponds to an enlarged version of the button 620 of FIG. 6. Moreover, the button 720 is displayed as a result of determining a high level of engagement from the user. Further, the description 630 of FIG. 3 does not appear in the user interface 700 because of the high level of engagement from the user.

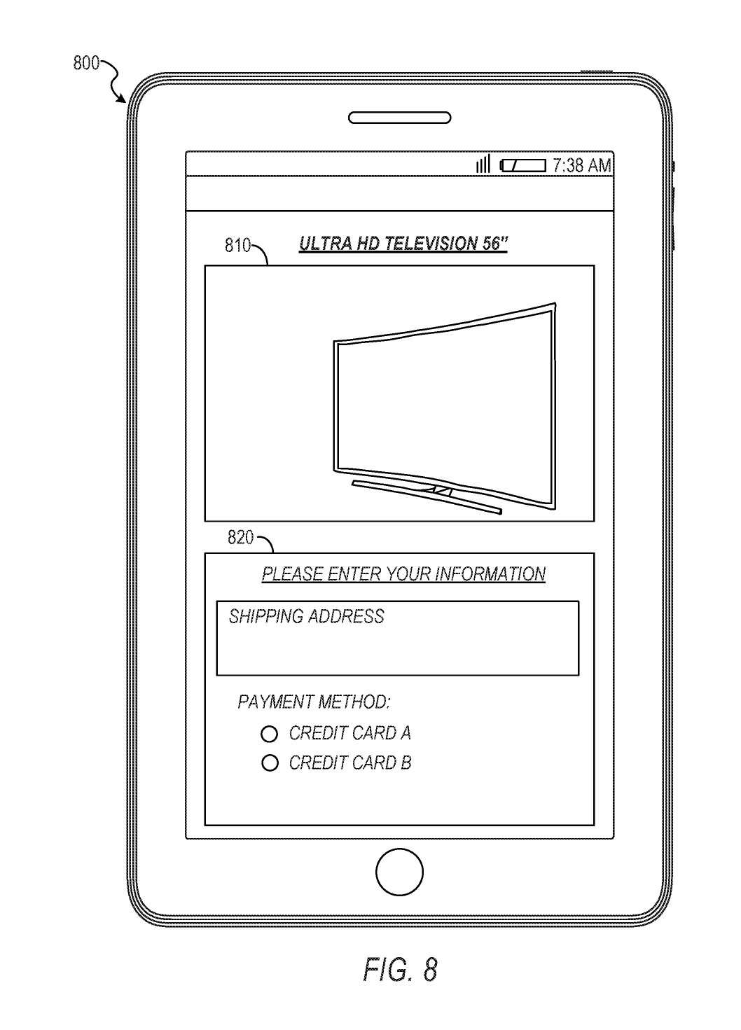

FIG. 8 is an example user interface 800 that depicts a modified item page, according to some example embodiments. The user interface 800 may be displayed on a screen of a mobile device. As shown in FIG. 8, the user interface 800 includes a picture 810 of an item (e.g., television). The user interface 800 also includes a section 820 that includes a field for receiving purchase information from a user. Further, the modified item page may be displayed as a result of a high level of engagement to the user interface 600 of FIG. 6. The section 820 may be an additional page that is generated by the generation module 230 as a result of the determination of the high level of engagement from the user.

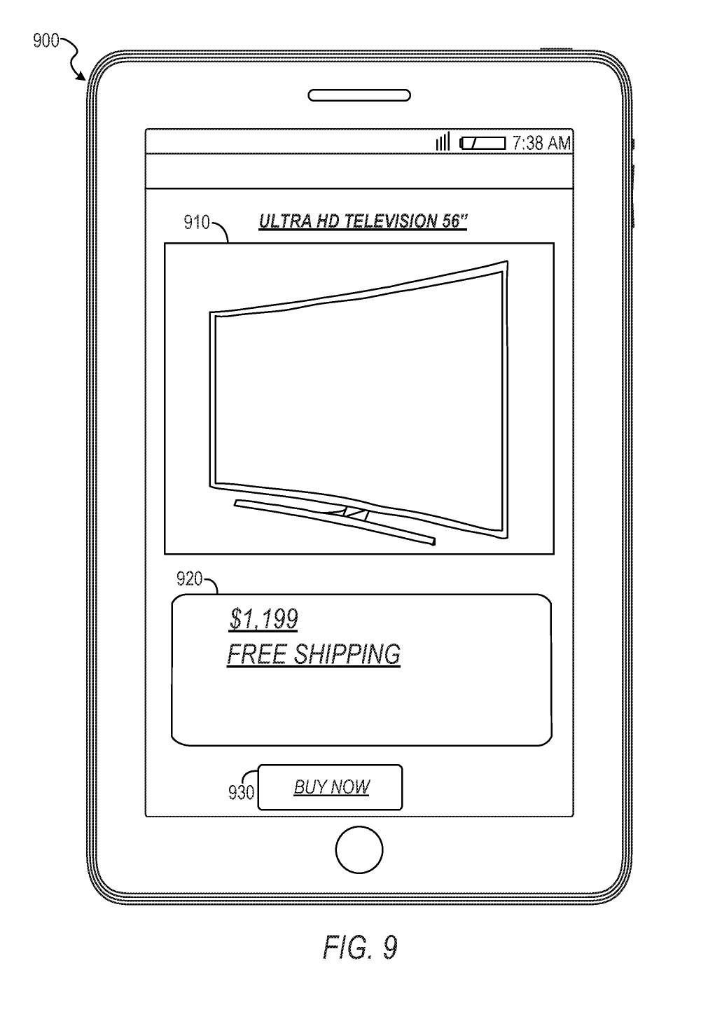

FIG. 9 is an example user interface 900 that depicts a modified item page, according to some example embodiments. The user interface 900 may be displayed on a screen of a mobile device. As shown in FIG. 9, the user interface 900 includes a picture 910 of an item (e.g., television). The user interface 900 also includes a description 920 of an item. Further, the modified item page may be displayed as a result of low level of engagement to the user interface 600 of FIG. 6. In particular, the description 920 of the item corresponds to an enlarged version of the description 630 of FIG. 6. The description 920 is used to draw an attention of a user to the user interface 900 in an attempt to increase the level of engagement from the user. Further, the user interface 900 includes a button 930 that is operable to initiate a purchase of the item.

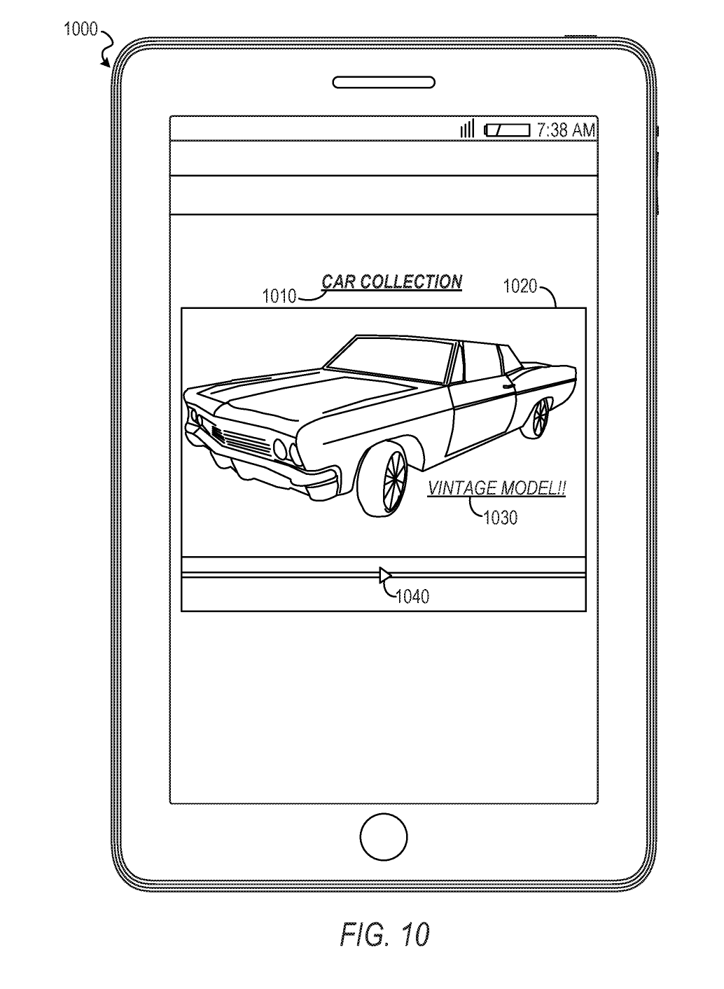

FIG. 10 is an example user interface 1000 that depicts content of a vehicle, according to some example embodiments. The user interface 1000 may be displayed on a screen of a mobile device. Further, as shown in FIG. 10, the user interface 1000 includes a title 1010 of the content and the content 1020 itself. The content 1020 may be displayed in the user interface 1000 in the form of a frame of a video clip, an image among a slide show presentation, and the like. Moreover, the content 1020 is labeled with a description 1030 that is used to draw a user's attention to the user interface. Accordingly, the description 1030 is displayed in the user interface 1000 as a result of detecting a low level of engagement from the user. The user interface 1000 also includes a progress bar 1040 that indicates a location of the content 1020 within the video clip or the slide show presentation. Further, the modification module 250 causes the video clip or the slide show presentation to jump to a position indicated by the progress bar 1040 in order to display the content 1020.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Example Machine Architecture and Machine-Readable Medium

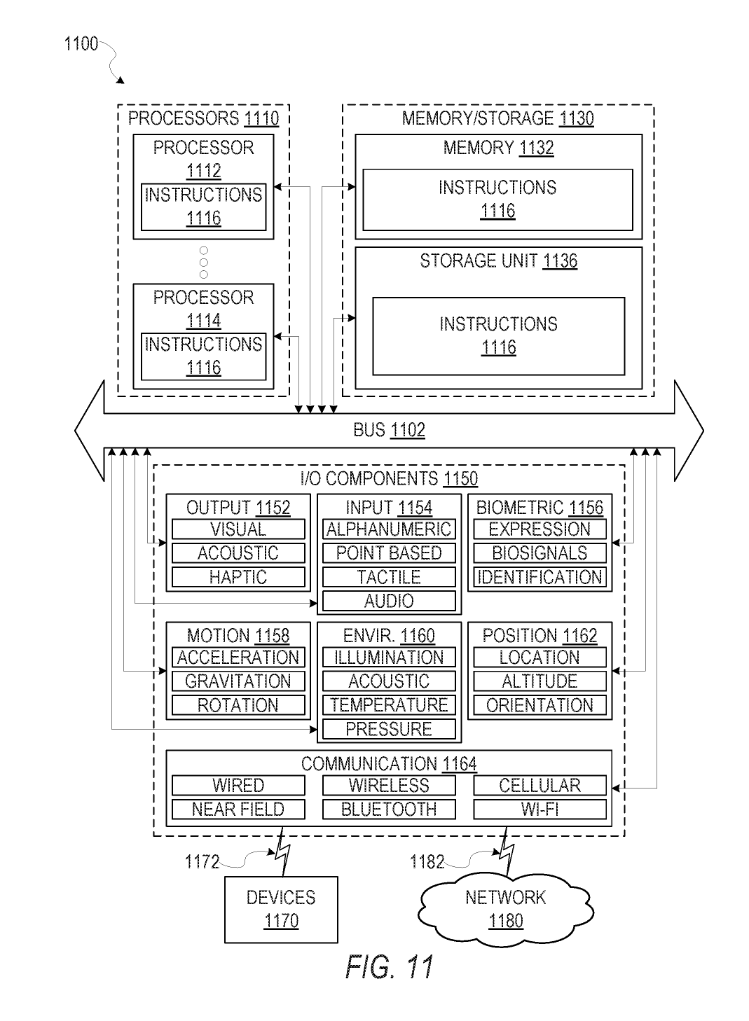

FIG. 11 is a block diagram illustrating components of a machine 1100, according to some example embodiments, able to read instructions from a machine-readable medium (e.g., a machine-readable storage medium) and perform any one or more of the methodologies discussed herein. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. For example the instructions may cause the machine to execute the flow diagrams of FIGS. 3-5. Additionally, or alternatively, the instructions may implement the modules depicted in FIG. 2 and so forth. The instructions transform the general, non-programmed machine into a particular machine specially configured to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1112 and processor 1114 that may execute instructions 1116. The term “processor” is intended to include multi-core processor that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core process), multiple processors with a single core, multiple processors with multiples cores, or any combination thereof.

The memory/storage 1130 may include a memory 1132, such as a main memory, or other memory storage, and a storage unit 1136, both accessible to the processors 1110 such as via the bus 1102. The storage unit 1136 and memory 1132 store the instructions 1116 embodying any one or more of the methodologies or functions described herein. The instructions 1116 may also reside, completely or partially, within the memory 1132, within the storage unit 1136, within at least one of the processors 1110 (e.g., within the processor's cache memory), or any suitable combination thereof, during execution thereof by the machine 1100. Accordingly, the memory 1132, the storage unit 1136, and the memory of processors 1110 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions 1116. The term “machine-readable medium” shall also be taken to include any medium, or combination of multiple media, that is capable of storing instructions (e.g., instructions 1116) for execution by a machine (e.g., machine 1100), such that the instructions, when executed by one or more processors of the machine 1100 (e.g., processors 1110), cause the machine 1100 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example embodiments, the I/O components 1150 may include biometric components 1156, motion components 1158, environmental components 1160, or position components 1162 among a wide array of other components. For example, the biometric components 1156 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via coupling 1182 and coupling 1172 respectively. For example, the communication components 1164 may include a network interface component or other suitable device to interface with the network 1180. In further examples, communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a Universal Serial Bus (USB)).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1180 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1180 or a portion of the network 1180 may include a wireless or cellular network and the coupling 1182 may be a Code Division Multiple Access (CDMA) connection, a Global System for Mobile communications (GSM) connection, or other type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to devices 1170. The term “transmission medium” shall be taken to include any intangible medium that is capable of storing, encoding, or carrying instructions 1116 for execution by the machine 1100, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a display module configured to cause display of a user interface that depicts an item page that describes an item available for sale from a network publication system, the user interface being displayed on a screen of a mobile device;
a reception module configured to receive a signal, generated by a wearable device worn by a user, that measures a physical response of the user to the displayed user interface on the screen of the mobile device;
a determination module configured to determine that the signal generated by the wearable device indicates a level of engagement from the user that transgresses a threshold level of engagement; and
a modification module configured to modify content depicted in the user interface displayed on the screen of the mobile device based on the determining that the level of engagement from the user transgresses the threshold level of engagement.

2. The system of claim 1, wherein the determination module is further configured to:
determine an engagement score based on the signal generated by the wearable device; and
compare the engagement score with data that corresponds to the threshold level of engagement.

3. The system of claim 1, wherein:
the signal generated by the wearable device indicates a heart rate of the user; and
the determination module is further configured to determine that the heart rate of the user is above a threshold value.

4. The system of claim 1, wherein:
the signal generated by the wearable device indicates a facial expression of the user; and
the determination module is further configured to determine that the facial expression of the user matches a set of predefined criteria.

5. The system of claim 1, wherein:
the signal generated by the wearable device indicates movement of the user; and
the determination module is further configured to determine that movement of the user exceeds a threshold amount of movement.

6. The system of claim 1, wherein the reception module is further configured to receive information that indicates a result of an eye tracking performed, by the wearable device, on the user.

7. The system of claim 1, wherein:
the modification module is further configured to increase a size of a portion of the item page; and
the portion of the item page is selectable to initiate a purchase of the item.

8. The system of claim 1, further comprising a generation module configured to generate an additional page that includes a field for receiving purchase information from the user, the generating being based on the determination that the level of engagement of the user transgresses the threshold level of engagement, and wherein the display module is further configured to cause display of the additional page in the user interface.

9. The system of claim 1, wherein the modification module is further configured to reduce an amount of the content displayed in the user interface.

10. The system of claim 9, wherein the modification module is further configured to remove a description of the item available for sale from the item page depicted in the user interface.

11. The system of claim 1, further comprising a storage module configured to store in a database an indication of the determined engagement score, the indication being associated with the item page.

12. A method comprising:
causing display of a user interface that depicts an item page that describes an item available for sale from a network publication system, the user interface being displayed on a screen of a mobile device;
receiving a signal, generated by a wearable device worn by a user, that measures a physical response of the user to the displayed user interface on the screen of the mobile device;
determining, using one or more processors, that the signal generated by the wearable device indicates a level of engagement from the user that transgresses a threshold level of engagement; and
modifying content depicted in the user interface displayed on the screen of the mobile device based on the determining that the level of engagement from the user transgresses the threshold level of engagement.

13. The method of claim 12, wherein the determining includes:
determining an engagement score based on the signal generated by the wearable device; and
comparing the engagement score with data that corresponds to the threshold level of engagement.

14. The method of claim 12, wherein:
the signal generated by the wearable device indicates a heart rate of the user; and
the determining includes determining that the heart rate of the user is above a threshold value.

15. The method of claim 12, wherein:
the signal generated by the wearable device indicates a facial expression of the user; and
the determining includes determining that the facial expression of the user matches a set of predefined criteria.

16. The method of claim 12, wherein receiving the signal includes receiving information that indicates a result of an eye tracking performed, by the wearable device, on the user.

17. The method of claim 12, further comprising increasing a size of a portion of the item page; and wherein the portion of the item page is selectable to initiate a purchase of the item.

18. The method of claim 12, further comprising:
generating an additional page that includes a field for receiving purchase information from the user, the generating being based on the determination that the level of engagement of the user transgresses the threshold level of engagement; and
causing display of the additional page in the user interface.

19. The method of claim 12, further comprising removing a description of the item available for sale from the item page depicted in the user interface.

20. A non-transitory machine-readable medium storing instructions that, when executed by one or more processors of a machine, cause the machine to perform operations comprising:
causing display of a user interface that depicts an item page that describes an item available for sale from a network publication system, the user interface being displayed on a screen of a mobile device;
receiving a signal, generated by a wearable device worn by a user, that measures a physical response of the user to the displayed user interface on the screen of the mobile device;
determining that the signal generated by the wearable device indicates a level of engagement from the user that transgresses a threshold level of engagement; and
modifying content depicted in the user interface displayed on the screen of the mobile device based on the determining that the level of engagement from the user transgresses the threshold level of engagement.
